(19) United States
(12) Patent Application Publication
(10) Pub. No.: US 2025/0386291 A1
(43) Pub. Date: Dec. 18, 2025

(54) TARGET WAKE-UP TIME (TWT) TEARDOWN METHOD. ELECTRONIC DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/874,938

(22) PCT Filed: Jun. 14, 2022
(86) PCT No.: PCT/CN2022/098728

§ 371 Date: Dec. 13, 2024

(51) Int. Cl. H04W 52/02

(52) U.S. Cl. CPC H04W 52/0216

(57) ABSTRACT

A method, electronic device, and non-transitory computer-readable storage medium for performing Target Wake Time (TWT) teardown operations in multi-link communication systems are disclosed. The method involves sending a radio frame from a first multi-link device to indicate tearing down TWT setups for one or more communication links affiliated with the same multi-link device. The radio frame may indicate tearing down TWT setups for all or part of the communication links. For all links teardown, the radio frame includes a TWT flow field comprising a TWT flow identifier subfield and a Teardown All TWT subfield. For partial teardown, the radio frame includes a TWT flow field with subfields such as a link identifier (ID) bitmap presence subfield and a link ID bitmap subfield. This innovation facilitates efficient management of TWT setups in multi-link environments, optimizing resource utilization and power management.

### CROSS-REFERENCE TO RELATED APPLICATION

The present application is a U.S. National Stage of International Application No. PCT/CN2022/098728, filed on Jun. 14, 2022, the contents of which are incorporated herein by reference in their entirety.

### TECHNICAL FIELD

Embodiments of the present disclosure relate to the field of mobile communication technology, in particular to a target wake-up time (TWT) teardown method, an electronic device and a storage medium.

### BACKGROUND

With the rapid development of mobile communication technology, Wireless Fidelity (Wi-Fi) technology has achieved tremendous advancements in transmission rates, throughput, and other aspects. Currently, research in Wi-Fi technology focuses on areas such as 320 MHz bandwidth transmission, aggregation and coordination of multiple frequency bands, with primary application scenarios including video transmission, Augmented Reality (AR), and Virtual Reality (VR).

Specifically, aggregation and coordination of multiple frequency bands refer to devices communicating simultaneously on 2.4 GHz, 5.8 GHZ, 6 GHZ, and other frequency bands. For scenarios where devices communicate on multiple frequency bands simultaneously, new Media Access Control (MAC) mechanisms need to be defined for management. Furthermore, aggregation and coordination of multiple frequency bands are expected to support low-latency transmission.

Currently, in aggregation and coordination of multiple frequency bands technology, a maximum bandwidth to be supported is 320 MHz (160 MHz+160 MHz), and the technology may, support for 240 MHz (160 MHz+80 MHz) and other bandwidths specified by existing standards.

In the Wi-Fi technology currently being studied, there is a target wake-up time (TWT) setup mechanism. Therefore, a TWT teardown method needs to be provided to improve the TWT mechanism.

### SUMMARY

Embodiments of the present disclosure provide a target wake-up time (TWT) teardown method, an electronic device and a storage medium, so as to provide a TWT teardown manner.

In an aspect, an embodiment of the present disclosure provides a TWT teardown method, which is performed by a first multi-link device, and includes:
sending a target radio frame, where the target radio frame indicates tearing down TWT setup for one or more target communication links, and the one or more target communication links are affiliated with a same multi-link device as the first multi-link device.

In another aspect, an embodiment of the present disclosure further provides an electronic device, which is a first multi-link device, and includes:
a sending module, configured to send a target radio frame, where the target radio frame indicates tearing down TWT setup for one or more target communication links, and the one or more target communication links are affiliated with a same multi-link device as the first multi-link device.

An embodiment of the present disclosure further provides an electronic device, which includes a memory, a processor and a computer program stored in the memory and capable of running on the processor, and when the processor executes the program, the method according to one or more embodiments of the present disclosure is implemented.

An embodiment of the present disclosure further provides a computer-readable storage medium, on which a computer program is stored, when the computer program is executed by a processor, the method according to one or more embodiments of the present disclosure is implemented.

In the embodiment of the present disclosure, the first multi-link device sends a target radio frame. The target radio frame indicates tearing down TWT setup for one or more than one (more than one i.e., at least two) target communication links, so as to provide a teardown manner of TWT and improve the TWT mechanism.

Additional aspects and advantages of embodiments of the present disclosure will be given in part in the following description, and these will become apparent from the following description, or will be learned through the practice of the present disclosure.

### BRIEF DESCRIPTION OF DRAWINGS

In order to more clearly illustrate technical solutions in embodiments of the present disclosure, a brief introduction will be given below to the accompanying drawings required in the description of the embodiments of the present disclosure. It is evident that the accompanying drawings in the following of description are only some embodiments of the present disclosure. For those of ordinary skill in the art, other accompanying drawings can be obtained based on these accompanying drawings without paying creative labor.

FIG. 1 is a first flowchart of a TWT teardown method according to an embodiment of the present disclosure.

FIG. 2 is a schematic diagram of a first example according to an embodiment of the present disclosure.

FIG. 3 is a second flowchart of a TWT teardown method according to an embodiment of the present disclosure.

FIG. 4 is a third flowchart of a TWT teardown method according to an embodiment of the present disclosure.

FIG. 5 is a fourth flowchart of a TWT teardown method according to an embodiment of the present disclosure.

FIG. 6 is a first schematic structural diagram of an electronic device according to an embodiment of the present disclosure.

FIG. 7 is a second schematic structural diagram of an electronic device according to an embodiment of the present disclosure.

### DETAILED DESCRIPTION

The term “and/or” in the embodiments of the present disclosure describes the relationship of related objects, means that there can be three kinds of relationships, for example, A and/or B, which can mean that A exists alone, A and B exist together, and B exists alone. The character “/” generally indicates that the associated object is an “or” relationship.

In the embodiment of the present disclosure, the term “plurality” means two or more, and other quantifiers are similar.

Reference will now be made in detail to exemplary embodiments, examples of which are illustrated in the accompanying drawings. When the following description refers to the accompanying drawings, unless otherwise indicated, the same numbers in different accompanying drawings indicate the same or similar elements. Implementations described in the following exemplary embodiments do not represent all implementations consistent with the present disclosure. Rather, they are merely examples of apparatuses and methods consistent with some aspects of the present disclosure as detailed in the appended claims.

Terms used in the present disclosure are only for a purpose of describing specific embodiments, and are not limiting the present disclosure. Singular forms of “a,” said,” and “the” used in the present disclosure and in the appended claims are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the present disclosure, these information should not be limited to these terms. These terms are used only to distinguish the same type of information from one another. For example, without departing from the scope of the present disclosure, first information may also be named as second information, and similarly, the second information may also be named as the first information. Depending on the context, for example, the word “if” as used herein can be interpreted as “at” or “when” or “in response to determining”.

The technical solutions in the embodiments of the present disclosure will be clearly and completely described below in conjunction with the accompanying drawings in the embodiments of the present disclosure. The described embodiments are only a part of the embodiments of the present disclosure, not all embodiments. Based on the embodiments in the present disclosure, all other embodiments obtained by those of ordinary skills in the art without making creative efforts belong to the protection scope of the present disclosure.

Embodiments of the present disclosure provide a target wake-up time (TWT) teardown method, an electronic device and a storage medium, so as to provide a TWT teardown manner.

The method and the apparatus are based on the same application concept. Because the principle of solving problems is similar, the implementation of the apparatus and the method can be referred to each other, and the repetition is not repeated here.

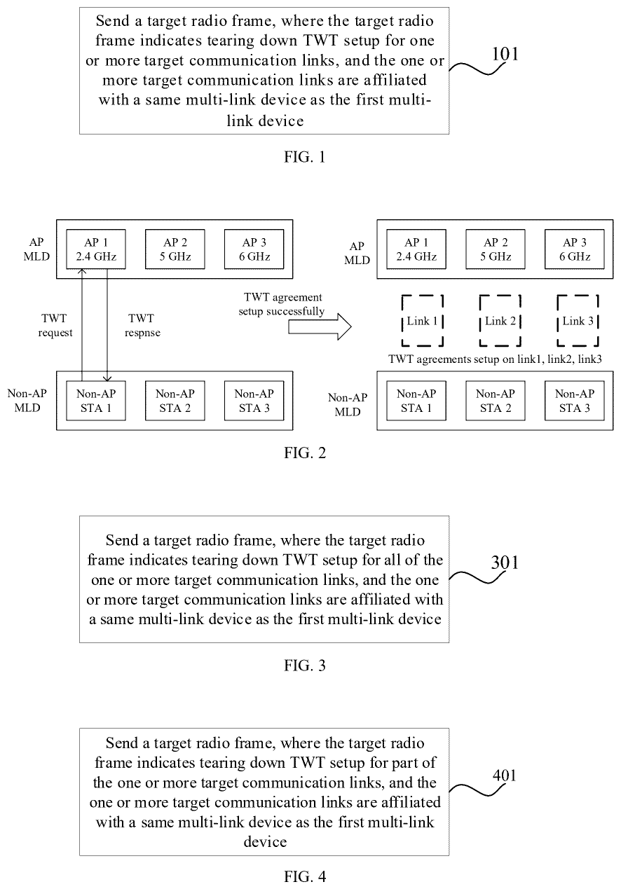

As shown in FIG. 1, an embodiment of the present disclosure provides a TWT teardown method. In some examples, the method may be performed by a first multi-link device, which can be either an Access Point Multi-Link Device (AP MLD) or a Station (i.e., non-AP MLD) that supports multi-links. The method may include the following step.

At step 101, a target radio frame is sent, where the target radio frame indicates tearing down TWT setup for one or more target communication links, and the one or more target communication links are affiliated with a same multi-link device as the first multi-link device.

As a first example, referring to FIG. 2, firstly, an application scenario of the target wake-up time (TWT) teardown method according to the embodiments of the present disclosure is introduced. In this scenario, AP MLD has three affiliated APs: AP 1 operates on 2.4 GHz band, AP 2 operates on 5 GHz band, and AP 3 operates on 6 GHz band. Non-AP STA 1 affiliated with the non-AP MLD sends three TWT elements in a TWT request to AP 1 affiliated with the AP MLD.

These three TWT elements indicate the links of AP 1, AP 2, and AP 3 requesting three links to be setup TWT agreements, respectively, have different TWT parameters, such as target wake up time, and all are with a value of Request TWT in the TWT Setup Command field.

AP 1 sends three TWT elements in a TWT response to non-AP STA 1 and these three TWT elements indicate the links of AP 1, AP 2, and AP 3 respectively; and they are all with a value of Accept TWT in the TWT Setup Command field.

After successful TWT agreements setup on the three links, three TWT SPs (service periods) with different TWT parameters exist on these three links (Link 1 between AP 1 and non-AP STA 1, Link 2 between AP 2 and non-AP STA 2, and Link 3 between AP 3 and non-AP STA 3), respectively.

For these three TWT agreements, the Target Wake Time field of the TWT element that indicates Link 1 is in reference to the Timer Synchronization Function (TSF) time of Link 1, the Target Wake Time field of the TWT element that indicates Link 2 is in reference to the TSF time of Link 2 and the Target Wake Time field of the TWT element that Link 3 is in reference to the TSF time of Link 3.

In the embodiment of the present disclosure, the first multi-link device sends a target radio frame. The target radio frame indicates tearing down TWT setup for one or more than one (more than one i.e., at least two) target communication links, so as to provide a teardown manner of TWT and improve the TWT mechanism. The one or more target communication links are affiliated with a same multi-link device as the first multi-link device, i.e., when initiating the teardown of TWT setup, the first multi-link device sends a target radio frame in a link, which includes TWT parameter information elements of other STA affiliated with the same MLD. For example, as shown in FIG. 2, a first multi-link device, non-AP STA 1, sends a target radio frame to AP 1 affiliated with AP MLD, and the target radio frame carries the teardown of TWT setup for one or more links in link1 to link3.

When the target radio frame indicates to tear down TWT setup for multiple target communication links, it is not necessary to send signaling messages for tearing down TWT setup separately in each link, which can further reduce signaling consumption, save network resources, as well as saves device power.

Referring to FIG. 3, an embodiment of the present disclosure provides a TWT teardown method. In some examples, the method may be performed by a first multi-link device, and the method may include the following step.

At step 301, a target radio frame is sent, where the target radio frame indicates tearing down TWT setup for all of the one or more target communication links, and the one or more target communication links are affiliated with a same multi-link device as the first multi-link device.

A scenario applied by the TWT teardown method provided by the embodiment of the present disclosure refers to the first example, and is not repeated here. The first multi-link device sends a target radio frame. The target radio frame indicates tearing down TWT setup for all of the one or more target communication links, so as to provide a teardown manner of TWT and improve the TWT mechanism. The one or more target communication links are affiliated with a same multi-link device as the first multi-link device, i.e., when initiating the teardown of TWT setup, the first multi-link device sends a target radio frame in a link, which includes TWT parameter information elements of other STA affiliated with the same MLD. For example, as shown in FIG. 2, a first multi-link device, non-AP STA 1, sends a target radio frame to AP 1 affiliated with AP MLD, and the target radio frame carries the teardown of TWT setup in link1 to link3.

When the target radio frame indicates to tear down TWT setup for all of the one or more target communication links, it is not necessary to send signaling messages for tearing down TWT setup separately in each link, which can further reduce signaling consumption, save network resources, as well as saves device power.

An embodiment of the present disclosure provides a TWT teardown method. In some examples, the method may be performed by a first multi-link device, and the method may include the following step.

A target radio frame is sent, where the target radio frame indicates tearing down the TWT setup for all of the one or more target communication links, and the one or more target communication links are affiliated with a same multi-link device as the first multi-link device. The target radio frame includes a TWT flow field.

The TWT flow field includes a TWT flow identifier subfield and a Teardown All TWT subfield.

A scenario applied by the TWT teardown method provided by the embodiment of the present disclosure refers to the first example, and is not repeated here. As a second example, refer to Table 1, which shows a format of TWT flow field provided by the embodiment of the present disclosure.

TABLE 1

| | | | | |
|---|---|---|---|---|
| TWT Flow | Reserved | Negotiation | Teardown | Link ID |
| Identifier | | type | All TWT | Bitmap |

The TWT flow identifier subfield is configured to identify a TWT flow, and the Teardown All TWT subfield is configured to identify whether to tear down all TWT setups.

In an embodiment, the TWT flow identifier subfield is set to a first preset identifier, and the Teardown All TWT subfield is set to a second preset identifier. For example, if the first preset identifier is Reserved and the second preset identifier is 1, the TWT Flow identifier subfield in the TWT flow field is set to reserved, and the teardown ALL TWT subfield is set to “1,” which identifies to tear down TWT in all links. In some examples, the negotiation Type may be set to 0 or 1.

Referring to FIG. 4, an embodiment of the present disclosure provides a TWT teardown method. In some examples, the method may be performed by a first multi-link device, and the method may include the following step.

At step 401, sending a target radio frame, where the target radio frame indicates tearing down TWT setup for part of the one or more target communication links, and the one or more target communication links are affiliated with a same multi-link device as the first multi-link device.

A scenario applied by the TWT teardown method provided by the embodiment of the present disclosure refers to the first example, and is not repeated here. The first multi-link device sends a target radio frame. The target radio frame indicates tearing down TWT setup for part of the one or more target communication links, so as to provide a teardown manner of TWT and improve the TWT mechanism. The one or more target communication links are affiliated with a same multi-link device as the first multi-link device, i.e., when initiating the teardown of TWT setup, the first multi-link device sends a target radio frame in a link, which includes TWT parameter information elements of other STA affiliated with the same MLD. For example, as shown in FIG. 2, a first multi-link device, non-AP STA 1, sends a target radio frame to AP 1 affiliated with AP MLD, and the target radio frame carries the teardown of part of TWT setup among link1 to link3. In some examples, in the embodiment of the present disclosure, the Teardown All TWT subfield is set to a third preset identifier, and the third preset identifier may be reserved or other special identifiers. The link ID bitmap subfield is set as a fourth preset identifier, for example, the fourth preset identifier is set to “1,” which identifies that the TWT setup in the corresponding link needs to be torn down.

An embodiment of the present disclosure provides a TWT teardown method. In some examples, the method may be performed by a first multi-link device, and the method may include the following step.

A target radio frame is sent, where the target radio frame indicates tearing down the TWT setup for part of the one or more target communication links, and the one or more target communication links are affiliated with a same multi-link device as the first multi-link device. The target radio frame includes a TWT flow field.

The TWT flow field includes a link identifier (ID) bitmap presence subfield and a link ID bitmap subfield; As a third example, refer to Table 2, which shows a format of the TWT flow field provided by the embodiment of the present disclosure in the case of tearing down the TWT setup of part of the one or more target communication links.

TABLE 2

| | | | | |
|---|---|---|---|---|
| TWT Flow | Reserved | Link ID | Negotiation | Link ID |
| Identifier | | Bitmap | Type | Bitmap |
| | | Presence | | |

The Link ID Bitmap Presence subfield is configured to identify whether the Link ID Bitmap subfield exists. For example, if the Link ID Bitmap Presence subfield is set to 1, it identifies that the Link ID Bitmap subfield exists. The link ID bitmap indicates TWT setup that needs to be torn down. For example, if a corresponding bit in the link ID bitmap is set to “1,” which identifies that the TWT setup for the corresponding link needs to be torn down. In some examples, in the case of tearing down TWT setups for part of the one or more target communication links, the first multi-link device sends a target radio frame corresponding to each TWT setup to be torn down respectively.

An embodiment of the present disclosure provides a TWT teardown method. In some examples, the method may be performed by a first multi-link device, and the method may include the following step.

A target radio frame is sent, where the target radio frame indicates tearing down the TWT setup for part of the one or more target communication links, and the one or more target communication links are affiliated with a same multi-link device as the first multi-link device.

The target radio frame includes a TWT flow field.

The TWT flow field includes a link ID bitmap presence subfield, a link ID bitmap subfield, and a Teardown All TWT subfield. As a fourth example, refer to Table 3, which shows a format of the TWT flow field provided by the embodiment of the present disclosure in the case of tearing down the TWT setup of part of the one or more target communication links.

TABLE 3

| | | | | | |
|---|---|---|---|---|---|
| TWT Flow | Reserved | Link ID | Negotiation | Teardown | Link ID |
| Identifier | | Bitmap | Type | All TWT | Bitmap |
| | | Presence | | | |

The Teardown All TWT subfield is configured to identify whether the Link ID Bitmap subfield exists. For example, the Teardown All TWT subfield is set to reserved, which identifies that the Link ID Bitmap subfield exists. Or, the Link ID Bitmap Presence subfield is configured to identify whether the Link ID Bitmap subfield exists. For example, if the Link ID Bitmap Presence subfield is set to 1, it identifies that the Link ID Bitmap subfield exists.

The link ID bitmap subfield indicates the links to which the TWT element sent by a STA affiliated with an MLD applies, for example, indicates TWT setup that needs to be torn down. For example, if a corresponding bit in the link ID bitmap is set to “1,” which indicates that the TWT setup for the corresponding link needs to be torn down. In some examples, in the case of tearing down TWT setups for part of the one or more target communication links, the first multi-link device sends a target radio frame corresponding to each TWT setup to be torn down respectively.

An embodiment of the present disclosure provides a TWT teardown method. In some examples, the method may be performed by a first multi-link device, and the method may include the following step.

A target radio frame is sent, where the target radio frame indicates tearing down the TWT setup for part of the one or more target communication links, and the one or more target communication links are affiliated with a same multi-link device as the first multi-link device.

The target radio frame includes a TWT flow field.

The TWT flow field includes a link ID bitmap subfield and a Teardown All TWT subfield.

As a fifth example, refer to Table 4, which shows a format of the TWT flow field provided by the embodiment of the present disclosure in the case of tearing down the TWT setup of part of the one or more target communication links.

TABLE 4

| | | | | |
|---|---|---|---|---|
| TWT Flow | Reserved | Negotiation | Teardown | Link ID |
| Identifier | | Type | All TWT | Bitmap |

The Teardown All TWT subfield is configured to identify whether the Link ID Bitmap subfield exists. For example, the Teardown All TWT subfield is set to reserved, which identifies that the Link ID Bitmap subfield exists. The link ID bitmap indicates TWT setup that needs to be torn down. For example, if a corresponding bit in the link ID bitmap is set to “1,” which identifies that the TWT setup for the corresponding link needs to be torn down. In some examples, in the case of tearing down TWT setups for part of the one or more target communication links, the first multi-link device sends a target radio frame corresponding to each TWT setup to be torn down respectively.

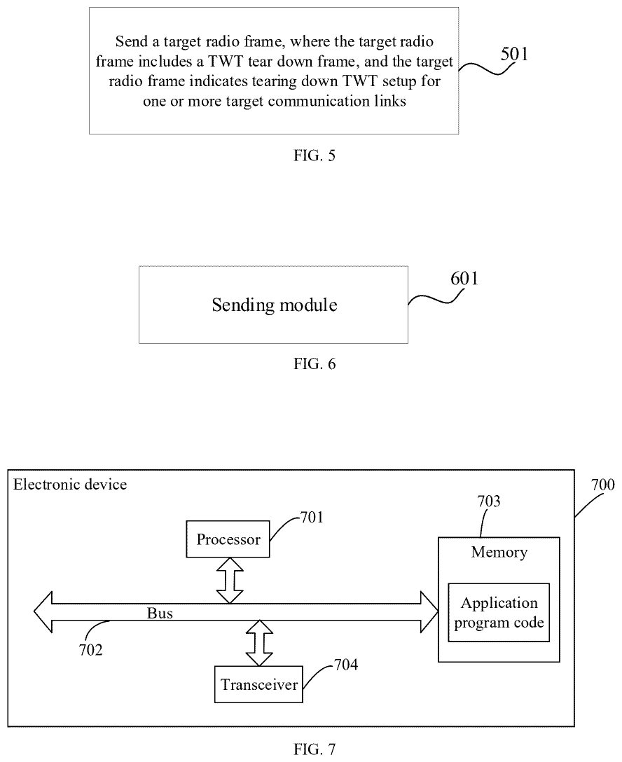

As shown in FIG. 5, an embodiment of the present disclosure provides a TWT teardown method. In some examples, the method may be performed by a first multi-link device, and the method may include the following step.

At step 501, a target radio frame is sent, where the target radio frame includes a TWT tear down frame, where the target radio frame indicates tearing down TWT setup for one or more target communication links, and the one or more target communication links are affiliated with a same multi-link device as the first multi-link device.

An action field of the TWT tear down frame includes a target identifier bit.

The target identifier bit indicates tearing down TWT for the one or more target communication links.

A scenario applied by the TWT teardown method provided by the embodiment of the present disclosure refers to the first example, and is not repeated here. The first multi-link device sends a TWT tear down frame, where an action field of the TWT tear down frame includes a target identifier bit; and the target identifier bit indicates tearing down TWT for the one or more target communication links. As a sixth example, refer to Table 5, which shows contents of the action field of the TWT tear down frame.

TABLE 5

| Order | Information |
|---|---|
| 1 | Category |
| 2 | Unprotected S1G action |
| 3 | One or more than one TWT flows |

In Table 5, the target identifier bit is 3, which indicates tearing down the TWT setup for the one or more target communication links.

In the embodiment of the present disclosure, the first multi-link device sends a target radio frame. The target radio frame indicates tearing down the TWT setup for one or more than one (more than one i.e., at least two) target communication links, so as to provide a teardown manner of TWT and improve the TWT mechanism.

Based on the same principle as the method provided by the embodiment of the present disclosure, an embodiment of the present disclosure further provides an electronic device, which is a first multi-link device, and the first multi-link device may be either an Access Point Multi-Link Device (AP MLD) or a Station (i.e., non-AP MLD) that supports multi-links. Referring to FIG. 6, the electronic device includes:
a sending module 601, configured to send a target radio frame; where the target radio frame indicates tearing down TWT setup for one or more target communication links, and the one or more target communication links are affiliated with a same multi-link device as the first multi-link device.

A scenario applied by the electronic device provided by the embodiment of the present disclosure refers to the first example mentioned above, and will not be repeated here.

In the embodiment of the present disclosure, the first multi-link device sends a target radio frame. The target radio frame indicates tearing down the TWT setup for one or more than one (more than one i.e., at least two) target communication links, so as to provide a teardown manner of TWT and improve the TWT mechanism. The one or more target communication links are affiliated with a same multi-link device as the first multi-link device, i.e., when initiating the teardown of TWT setup, the first multi-link device sends a target radio frame in a link, which includes TWT parameter information elements of other STA affiliated with the same MLD. For example, as shown in FIG. 2, a first multi-link device, non-AP STA 1, sends a target radio frame to AP 1 affiliated with AP MLD, and the target radio frame carries the teardown of TWT setup for one or more links in link1 to link3.

When the target radio frame indicates to tear down TWT setup for multiple target communication links, it is not necessary to send signaling messages for tearing down TWT setup separately in each link, which can further reduce signaling consumption, save network resources, as well as saves device power.

In some examples, in the embodiment of the present disclosure, the target radio frame indicating tearing down TWT setup for one or more target communication links includes:
the target radio frame indicating tearing down the TWT setup for all of the one or more target communication links;
or,
the target radio frame indicating tearing down the TWT setup for part of the one or more target communication links.

In some examples, in the embodiment of the present disclosure, in a case that the target radio frame indicates tearing down the TWT setup for all of the one or more target communication links, the target radio frame includes a TWT flow field;

the TWT flow field includes a TWT flow identifier subfield and a Teardown All TWT subfield.

In some examples, in the embodiment of the present disclosure, the TWT flow identifier subfield is set to a first preset identifier, and the Teardown All TWT subfield is set to a second preset identifier.

In some examples, in the embodiment of the present disclosure, in a case that the target radio frame indicates tearing down the TWT setup for part of the one or more target communication links,
the target radio frame includes a TWT flow field;
the TWT flow field includes a TWT flow identifier subfield and a Teardown All TWT;
the TWT flow field includes a link ID bitmap presence subfield, a link ID bitmap subfield, and a Teardown All TWT subfield; or,
the TWT flow field includes a link ID bitmap subfield and a Teardown All TWT subfield.

In some examples, in the embodiment of the present disclosure, the Teardown All TWT subfield is set to a third preset identifier, and the link ID bitmap subfield is set to a fourth preset identifier.

In some examples, in the embodiment of the present disclosure, the target radio frame includes a TWT tear down frame, an action field of the TWT tear down frame includes a target identifier bit; and
the target identifier bit indicates tearing down TWT for the one or more target communication links.

In the embodiment of the present disclosure, the sending module 601 sends a target radio frame. The target radio frame indicates tearing down the TWT setup for one or more than one (more than one i.e., at least two) target communication links, so as to provide a teardown manner of TWT and improve the TWT mechanism.

An embodiment of the present disclosure further provides a TWT teardown apparatus, which is applied to a first multi-link device, and the apparatus includes:
a radio frame sending module, configured to send a target radio frame; where the target radio frame indicates tearing down TWT setup for one or more target communication links, and the one or more target communication links are affiliated with a same multi-link device as the first multi-link device.

The apparatus further includes other modules of the electronic device of the preceding embodiment, which will not be repeated here.

In an embodiment, an embodiment of the present disclosure further provides an electronic device, as shown in FIG. 7. The electronic device 700 shown in FIG. 7 may be a server, including: a processor 701 and a memory 703. The processor 701 and the memory 703 are connected, for example, via a bus 702. In some examples, the electronic device 700 may further include a transceiver 704. It should be noted that there is not only one transceiver 704 in practical application, and the structure of the electronic device 700 does not constitute a limitation to the embodiment of the present disclosure.

The processor 701 may be a central processing unit (CPU), a general-purpose processor, a digital signal processor (DSP), an application specific integrated circuit (ASIC), a field programmable gate array (FPGA) or other programmable logic devices, transistor logic devices, hardware components or any combination thereof. Which may implement or perform various illustrative logical blocks, modules, and circuits described in connection with the present disclosure. The processor 701 may also be a combination that realizes computing functions, for example, including one or more microprocessor combinations, DSP and microprocessor combinations, etc.

The bus 702 may include a pathway to transmit information between the components described above. The bus 702 may be a peripheral component interconnect (PCI) bus or an extended industry standard architecture (EISA) bus, etc. The bus 702 may be divided into address bus, data bus, control bus, etc. For convenience of representation, only one thick line is used in FIG. 7, but it does not mean that there is only one bus or one type of bus.

The memory 703 may be a read only memory (ROM) or other types of static storage devices that can store static information and instructions, a random access memory (RAM) or other types of dynamic storage devices that can store information and instructions, as well as an electrically erasable programmable read only memory (EEPROM), a compact disc read only memory (CD-ROM) or other optical disc storage, optical disc storage (including compact disc, laser disc, optical disc, digital versatile disc, Blu-ray disc, etc.), magnetic disc storage medium or other magnetic storage devices, or any other medium that can be used to carry or store desired program codes in the form of instructions or data structures and can be accessed by a computer, but is not limited to this.

The memory 703 is configured to store application program code for executing the solution of the present disclosure, and the execution is controlled by the processor 701. The processor 701 is configured to execute the application program code stored in the memory 703, so as to realize the contents shown in the foregoing method embodiments.

The electronic device includes but is not limited to a mobile terminal such as a mobile phone, a laptop computer, a digital broadcast receiver, a Personal Digital Assistant (PDA), a PAD (tablet computer), a Portable Multimedia Player (PMP), an in-vehicle terminal (e.g., an in-car navigation terminal), etc., as well as a fixed terminal such as a digital TV or a desktop computer. The electronic device illustrated in FIG. 7 is merely an example and should not impose any limitations on the functionality and scope of use of embodiments of the present disclosure.

The server provided by the present disclosure may be a stand-alone physical server, a server cluster or distributed system including a plurality of physical servers, and a cloud server providing basic cloud computing services such as cloud services, cloud database, cloud computing, cloud functions, cloud storage, network services, cloud communications, middleware services, domain name services, security services, CDNs, and big data and artificial intelligence platforms. The terminal may be a smart phone, a tablet computer, a notebook computer, a desktop computer, a smart speaker, a smart watch, etc., but it is not limited to this. The terminal as well as the server may be connected directly or indirectly via wired or wireless communication, and the present disclosure is not limited herein.

An embodiment of that present disclosure provides a computer-readable storage medium, on which a computer program is store, which, when run on a computer, causes the computer to execute the corresponding contents of the foregoing method embodiments.

It should be understood that although the various steps in the flowchart of the accompanying drawings are shown sequentially as indicated by the arrows, the steps are not necessarily performed sequentially in the order indicated by the arrows. Unless explicitly stated herein, the execution of these steps is not strictly limited in order, and they can be executed in other orders. Moreover, at least a part of the steps in the flowchart of the accompanying drawings may include a plurality of sub-steps or stages, which may not necessarily be completed at the same time, but may be executed at different times, and the execution order may not necessarily be sequential, but may be executed alternately or alternatively with other steps or at least a part of sub-steps or stages of other steps.

It should be noted that the computer-readable medium mentioned above in the present disclosure may be a computer-readable signal medium or a computer-readable storage medium or any combination thereof. The computer-readable storage medium may be, for example, but is not limited to, a system, an apparatus or a device of electricity, magnetism, optics, electromagnetism, infrared rays, or semiconductors, or any combination thereof. More specific examples of the computer-readable storage medium may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium that contains or stores a program that may be used by or in combination with an instruction execution system, apparatus, or device. Whereas, in the present disclosure, a computer-readable signal medium may include a data signal propagated in a baseband or as part of a carrier carrying computer-readable program code. Such propagated data signals may take a variety of forms, including, but not limited to, electromagnetic signals, optical signals, or any suitable combination of the foregoing. The computer-readable signal medium may further be any computer-readable medium other than a computer-readable storage medium that can send, propagate, or transmit a program for use by or in connection with an instruction execution system, apparatus, or device. The program code contained on the computer-readable medium may be transmitted by any suitable medium, including, but not limited to: wire, fiber optic cable, RF (radio frequency), etc., or any suitable combination of the foregoing.

The computer-readable medium may be included in the electronic device; or it may be separate and not assembled into such electronic device.

The computer-readable medium carries one or more programs, which, when executed by the electronic device, cause the electronic device to perform the method shown in the above embodiments.

According to an aspect of the present disclosure, a computer program product or computer program is provided, which includes computer instructions stored in a computer-readable storage medium. A processor of a computer device reads the computer instructions from the computer-readable storage medium, and the processor executes the computer instructions, so that the computer device performs the methods provided in the various implementations described above.

Computer program codes for performing the operations of the present disclosure may be written in one or more programming languages or combinations thereof, including object-oriented programming languages such as Java, Smalltalk, C++, and conventional procedural programming languages such as “C” or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the accompanying drawings illustrate the architecture, functionality, and operation of systems, methods, and computer program products that may be implemented in accordance with various embodiments of the present disclosure. In this regard, each block in the flowchart or block diagram may represent a module, a program segment, or a part of code that contains one or more executable instructions for implementing specified logical functions. It should also be noted that in some implementations as replacements, the functions indicated in the blocks may also occur in a different order than indicated in the accompanying drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The modules described in the embodiments of the present disclosure may be realized by software or hardware. The name of a module does not, in some cases, constitute a limitation on the module itself. For example, module A may also be described as “module A for performing operation B”.

The above description is only the preferred embodiments of the present disclosure and the explanation of the applied technical principles. It should be understood by those skilled in the art that the scope of the disclosure involved in the present disclosure is not limited to the technical solution formed by a particular combination of the above technical features, but should also cover other technical solutions formed by any combination of the above technical features or their equivalent features without departing from the above disclosure concept. For example, a technical solution formed by interchanging the above features with (but not limited to) technical features having similar functions disclosed in the present disclosure.

1. A target wake-up time (TWT) teardown method, performed by a first multi-link device and the method comprising:
sending a radio frame, wherein the radio frame indicates tearing down TWT setup for one or more communication links, and the one or more communication links are affiliated with a same multi-link device as the first multi-link device.

2. The TWT teardown method according to claim 1, wherein the radio frame indicating tearing down TWT setup for one or more communication links comprises:
the radio frame indicating tearing down the TWT setup for all of the one or more communication links; or,
the radio frame indicating tearing down the TWT setup for part of the one or more communication links.

3. The TWT teardown method according to claim 2, wherein in a case that the radio frame indicates tearing down the TWT setup for all of the one or more communication links,
the radio frame comprises a TWT flow field;
the TWT flow field comprises a TWT flow identifier subfield and a Teardown All TWT subfield.

4. The TWT teardown method according to claim 3, wherein:
the TWT flow identifier subfield is set to a first preset identifier, and
the Teardown All TWT subfield is set to a second preset identifier.

5. The TWT teardown method according to claim 2, wherein in a case that the radio frame indicates tearing down the TWT setup for part of the one or more communication links:
the radio frame comprises a TWT flow field;
the TWT flow field comprises a link identifier (ID) bitmap presence subfield and a link ID bitmap subfield;
the TWT flow field comprises a link ID bitmap presence subfield, a link ID bitmap subfield, and a Teardown All TWT subfield; or
the TWT flow field comprises a link ID bitmap subfield and a Teardown All TWT subfield.

6. The TWT teardown method according to claim 5, wherein:
the Teardown All TWT subfield is set to a third preset identifier, and
the link ID bitmap subfield is set to a fourth preset identifier.

7. The TWT teardown method according to claim 1, wherein:
the radio frame comprises a TWT tear down frame;
an action field of the TWT tear down frame comprises an identifier bit; and
the identifier bit indicates tearing down TWT for the one or more communication links.

8. (canceled)

9. An electronic device comprising:
a memory,
a processor and
a computer program stored in the memory and executable on the processor, wherein the processor, when executing the program, is configured to:
send a radio frame, wherein the radio frame indicates tearing down target wake-up time (TWT) setup for one or more communication links, and the one or more communication links are affiliated with a same multi-link device as the first multi-link device.

10. A non-transitory computer-readable storage medium, applied to a first multi-link device, wherein the computer-readable storage medium stores a computer program which, when executed by a processor, causes the processor to execute a method comprising:
sending a radio frame, wherein the radio frame indicates tearing down target wake-up time (TWT) setup for one or more communication links, and the one or more communication links are affiliated with a same multi-link device as the first multi-link device.

11. The electronic device according to claim 9, wherein the radio frame indicating tearing down TWT setup for one or more communication links comprises:
the radio frame indicating tearing down the TWT setup for all of the one or more communication links; or,
the radio frame indicating tearing down the TWT setup for part of the one or more communication links.

12. The electronic device according to claim 11, wherein in a case that the radio frame indicates tearing down the TWT setup for all of the one or more communication links:
the radio frame comprises a TWT flow field; and
the TWT flow field comprises a TWT flow identifier subfield and a Teardown All TWT subfield.

13. The electronic device according to claim 12, wherein,
the TWT flow identifier subfield is set to a first preset identifier, and
the Teardown All TWT subfield is set to a second preset identifier.

14. The electronic device according to claim 11, wherein in a case that the radio frame indicates tearing down the TWT setup for part of the one or more communication links:
the radio frame comprises a TWT flow field;
the TWT flow field comprises a link identifier (ID) bitmap presence subfield and a link ID bitmap subfield;
the TWT flow field comprises a link ID bitmap presence subfield, a link ID bitmap subfield, and a Teardown All TWT subfield; or
the TWT flow field comprises a link ID bitmap subfield and a Teardown All TWT subfield.

15. The electronic device according to claim 14, wherein,
the Teardown All TWT subfield is set to a third preset identifier, and
the link ID bitmap subfield is set to a fourth preset identifier.

16. The electronic device according to claim 9, wherein:
the radio frame comprises a TWT tear down frame;
an action field of the TWT tear down frame comprises an identifier bit; and
the identifier bit indicates tearing down TWT for the one or more communication links.

17. The non-transitory computer-readable storage medium according to claim 10, wherein the radio frame indicating tearing down TWT setup for one or more communication links comprises:
the radio frame indicating tearing down the TWT setup for all of the one or more communication links; or,
the radio frame indicating tearing down the TWT setup for part of the one or more communication links.

18. The non-transitory computer-readable storage medium according to claim 17, wherein in a case that the radio frame indicates tearing down the TWT setup for all of the one or more communication links:
the radio frame comprises a TWT flow field; and
the TWT flow field comprises a TWT flow identifier subfield and a Teardown All TWT subfield.

19. The non-transitory computer-readable storage medium according to claim 18, wherein,
the TWT flow identifier subfield is set to a first preset identifier, and
the Teardown All TWT subfield is set to a second preset identifier.

20. The non-transitory computer-readable storage medium according to claim 18, wherein in a case that the radio frame indicates tearing down the TWT setup for part of the one or more communication links:
the radio frame comprises a TWT flow field;
the TWT flow field comprises a link identifier (ID) bitmap presence subfield and a link ID bitmap subfield;
the TWT flow field comprises a link ID bitmap presence subfield, a link ID bitmap subfield, and a Teardown All TWT subfield; or
the TWT flow field comprises a link ID bitmap subfield and a Teardown All TWT subfield.

21. The non-transitory computer-readable storage medium according to claim 20, wherein:
the Teardown All TWT subfield is set to a third preset identifier, and
the link ID bitmap subfield is set to a fourth preset identifier.
